(19) United States
(12) Patent Application Publication
(10) Pub. No.: US 2006/0128557 A1
(43) Pub. Date: Jun. 15, 2006

(54) Manufacturing method for electrochemical fuel cells

(76) Inventors: Sean M. MacKinnon, Burnaby (CA); Warren M. Williams, North Vancouver (CA); Gregory A. James, Coquitlam (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/012,860

(22) Filed: Dec. 14, 2004

(51) Int. Cl. H01M 4/88; C08J 5/22; H01M 8/10; H01M 4/94

(52) U.S. Cl. 502/101; 521/27; 429/44; 429/30

(57) ABSTRACT

Contamination of the ion-exchange membrane in an electrochemical fuel cell can significantly reduce its lifetime. One source of contamination is from sealant materials, more specifically volatile organic compounds (VOCs). Pursuant to the invention, an assembled membrane electrode assembly (MEA) is heated at a temperature of about 200° C. for about 2 hours. This removes a high percentage of VOCs present in the assembled MEA, more specifically present in the seals.

### BACKGROUND OF THE INVENTION

1. Field of the Invention

The present invention relates to electrochemical fuel cell manufacturing methods so as to address degradation mechanisms of fuel cell systems during operation. More particularly, the present invention relates to limiting silica contamination of ion-exchange membranes, filters and other components of the fuel cell system during operation.

2. Description of the Related Art

Electrochemical fuel cells convert reactants, namely fuel and oxidant fluid streams, to generate electric power and reaction products. Electrochemical fuel cells employ an electrolyte disposed between two electrodes, namely a cathode and an anode. The electrodes each comprise an electrocatalyst disposed at the interface between the electrolyte and the electrodes to induce the desired electrochemical reactions. The location of the electrocatalyst generally defines the electrochemically active area.

Polymer electrolyte membrane (PEM) fuel cells generally employ a membrane electrode assembly (MEA) consisting of an ion-exchange membrane disposed between two electrode layers comprising porous, electrically conductive sheet material as fluid diffusion layers, such as carbon fiber paper or carbon cloth. In a typical MEA, the electrode layers provide structural support to the ion-exchange membrane, which is typically thin and flexible. The membrane is ion conductive (typically proton conductive), and also acts as a barrier for isolating the reactant streams from each other. Another function of the membrane is to act as an electrical insulator between the two electrode layers. The electrodes should be electrically insulated from each other to prevent short-circuiting. A typical commercial PEM is a sulfonated perfluorocarbon membrane sold by E.I. Du Pont de Nemours and Company under the trade designation NAFION®.

The MEA contains an electrocatalyst, typically comprising finely comminuted platinum particles disposed in a layer at each membrane/electrode layer interface, to induce the desired electrochemical reaction. The electrodes are electrically coupled to provide a path for conducting electrons between the electrodes through an external load.

In a fuel cell stack, the MEA is typically interposed between two separator plates that are substantially impermeable to the reactant fluid streams. The plates act as current collectors and provide support for the electrodes. To control the distribution of the reactant fluid streams to the electrochemically active area, the surfaces of the plates that face the MEA may have open-faced channels formed therein. Such channels define a flow field area that generally corresponds to the adjacent electrochemically active area. Such separator plates, which have reactant channels formed therein are commonly known as flow field plates. In a fuel cell stack, a plurality of fuel cells are connected together, typically in series, to increase the overall output power of the assembly. In such an arrangement, one side of a given plate may serve as an anode plate for one cell and the other side of the plate may serve as the cathode plate for the adjacent cell. In this arrangement, the plates may be referred to as bipolar plates.

The fuel fluid stream that is supplied to the anode typically comprises hydrogen. For example, the fuel fluid stream may be a gas such as substantially pure hydrogen or a reformate stream containing hydrogen. Alternatively, a liquid fuel stream such as aqueous methanol may be used. The oxidant fluid stream, which is supplied to the cathode, typically comprises oxygen, such as substantially pure oxygen, or a dilute oxygen stream such as air. In a fuel cell stack, reactant streams are typically supplied and exhausted by respective supply and exhaust manifolds. Manifold ports are provided to fluidly connect the manifolds to the flow field area and electrodes. Manifolds and corresponding ports may also be provided for circulating a coolant fluid through interior passages within the stack to absorb heat generated by the exothermic fuel cell reactions.

It is desirable to seal reactant fluid stream passages to prevent leaks or inter-mixing of the fuel and oxidant fluid streams. U.S. Pat. No. 6,057,054, incorporated herein by reference in its entirety, discloses a sealant material impregnating into the peripheral region of the MEA and extending laterally beyond the edges of the electrode layers and membrane (i.e., the sealant material envelopes the membrane edge).

For a PEM fuel cell to be used commercially in either stationary or transportation applications, a sufficient lifetime is necessary. For example, 10,000-hour operations may be routinely required. In practice, there are significant difficulties in consistently obtaining sufficient lifetimes as many of the degradation mechanisms and effects remains unknown. Accordingly, there remains a need in the art to understand degradation of fuel cell components and to develop design improvements to mitigate or eliminate such degradation. Sealant constituents is believed to be a source of contaminants leading to the premature failure of ion-exchange membranes, mixed bed ion exchange filters and other components of the fuel cell system during operation. One way to address this issue is by physically separating the sealant material from the active area of the MEA, as disclosed in U.S. patent application Ser. No. 10/693,672. Another way to address this issue is by removing volatile organic compounds (VOCs), such as organo siloxanes, from sealing materials made of silicone rubber. During fuel cell operation, contaminant siloxanes slowly leach from the perimeter seal material and are deposited in the ion-exchange membrane as well as other components of the fuel cell system. For example, it can take up to 1,600 hours of operating time to remove 50% of the weight fraction of VOCs. Being able to remove VOCs before fuel cell operation begins would be very advantageous.

Removing VOCs through evaporation is not expected to be a viable solution for a number of reasons. One reason is that prolonged heating at temperatures greater than 120° C. is believed to cause MEA delamination as a result of PEM dimensional change and/or flow. Another reason, as stated by Pálinkó et al. (Journal of Molecular Structure 482-483 (1999) 29-32), is that irreversible degradation of Nafion® has been reported to occur through desulfonation and dehydroxylation at temperatures exceeding 150° C. A further reason is that dehydration of PEMs generally leads to very brittle membranes, which leads to MEA transfer formation and propagation.

An alternative process step to remove contaminant siloxanes from sealant materials involves solvent extraction of integrated seals upon removal from the MEA.

The present invention fulfills the need to remove residual organics from the MEA, more specifically the need to remove VOCs from sealant materials, and provides further related advantages.

### BRIEF SUMMARY OF THE INVENTION

A method for fabricating a membrane electrode assembly for use in an electrochemical fuel cell is provided. The method comprises the steps of providing an assembled membrane electrode assembly, and heating the assembled membrane electrode assembly at a temperature of at least 120° C. for at least 30 minutes.

In more specific embodiments, the heating step is performed at a temperature of at least 150° C. for at least one hour, or at a temperature of at least 200° C. for at least two hours.

In a further embodiment, the heating step is performed at a temperature not exceeding temperatures that would lead to irreversible damage to any of its parts.

In a still further embodiment, the assembled membrane electrode assembly comprises two fluid diffusion layers, an ion-exchange membrane interposed between the fluid diffusion layers, an electrocatalyst layer disposed at the interface between the ion-exchange membrane and each of the fluid diffusion layers, and a fluid impermeable integral seal impregnated in sealing regions of the fluid diffusion layers. The seal may comprise silicone.

These and other aspects of the invention will be evident upon reference to the attached figures and following detailed description.

### BRIEF DESCRIPTION OF THE DRAWINGS

FIG. 1 is a partial cross-sectional view of a prior art membrane electrode assembly;

FIG. 2 is a graph of the weight loss of seals versus the time such seals are heated, at various temperatures.

FIG. 3 is a graph of the comparison of weight loss of post baked seal to a low volatile variant of the same seal material.

In the above figures, similar references are used in different figures to refer to similar elements.

### DETAILED DESCRIPTION OF THE INVENTION

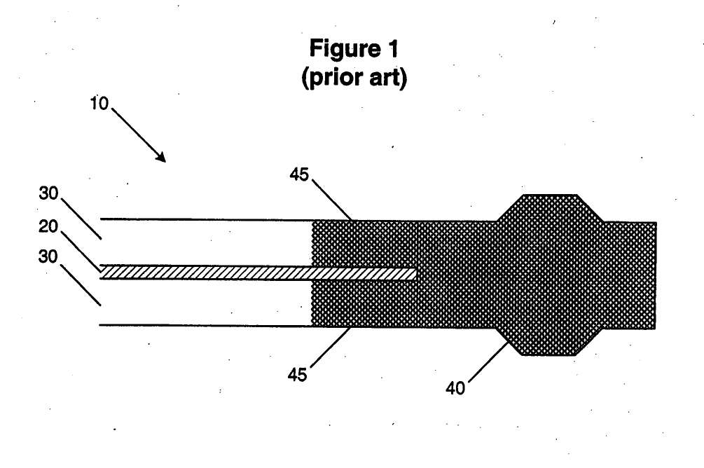

A cross-sectional representation of a perimeter edge of a sealed membrane electrode assembly (MEA) 10 as disclosed in U.S. Pat. No. 6,057,054 (the '054 patent), is illustrated in FIG. 1. Membrane 20 is interposed between fluid diffusion layers 30. Typically, fluid diffusion layers 30 comprise a porous electrically conductive sheet material of, for example, carbon fiber paper, woven or non-woven carbon fabric, or metal mesh or gauze. A thin layer of electrocatalyst (not shown in FIG. 1) is interposed between each of electrode layers 30 and membrane 20. A sealant material 40 impregnates into a sealing region 45 of the porous electrode layers 30 of MEA 10, and extends laterally beyond the edge of MEA 10 to envelope the peripheral region thereof.

As disclosed in the '054 patent, sealant material 40 may be a flow processable elastomer, such as, for example, a thermosetting liquid injection moldable compound (e.g., silicones, fluoroelastomers, fluorosilicones, ethylene propylene diene monomer (EPDM), and natural rubber). However, it has been discovered that the level of contamination of VOC and EOCs can induce premature failures in MEAs.

Specifically, when silicones are used as sealant material 40, mobile siloxanes may migrate into membrane 20 where they may then be chemically oxidized to form silicon dioxide derivatives. The contamination may subsequently lead to internal fractures within membrane 20 and ultimate failure of the fuel cell. Without being bound by theory, the source of the mobile siloxanes may include leachable oligomers or volatile low molecular weight siloxanes.

In particular, degradation appears to be localized within the region of MEA 10 where sealant material 40 is in close proximity to the active area of MEA 10. MEA degradation can be reduced by physically separating sealant material 40 from the active area of MEA 10, as disclosed in U.S. patent application Ser. No. 10/693,672. However, guarding from contaminant siloxanes originating from the manifold and port seals requires the removal prior to operation.

Another way to address the issue of MEA degradation is by evaporating the mobile, or volatile, siloxanes, which the present invention embodies.

Pursuant to an embodiment of the invention, assembly of MEA 10 is such that MEA 10 has sufficient dimensional stability to survive further heating as outlined below. For example, MEA 10 should be sufficiently dehydrated so as not to suffer from delamination (referred to above) when MEA 10 is further heated as outlined below.

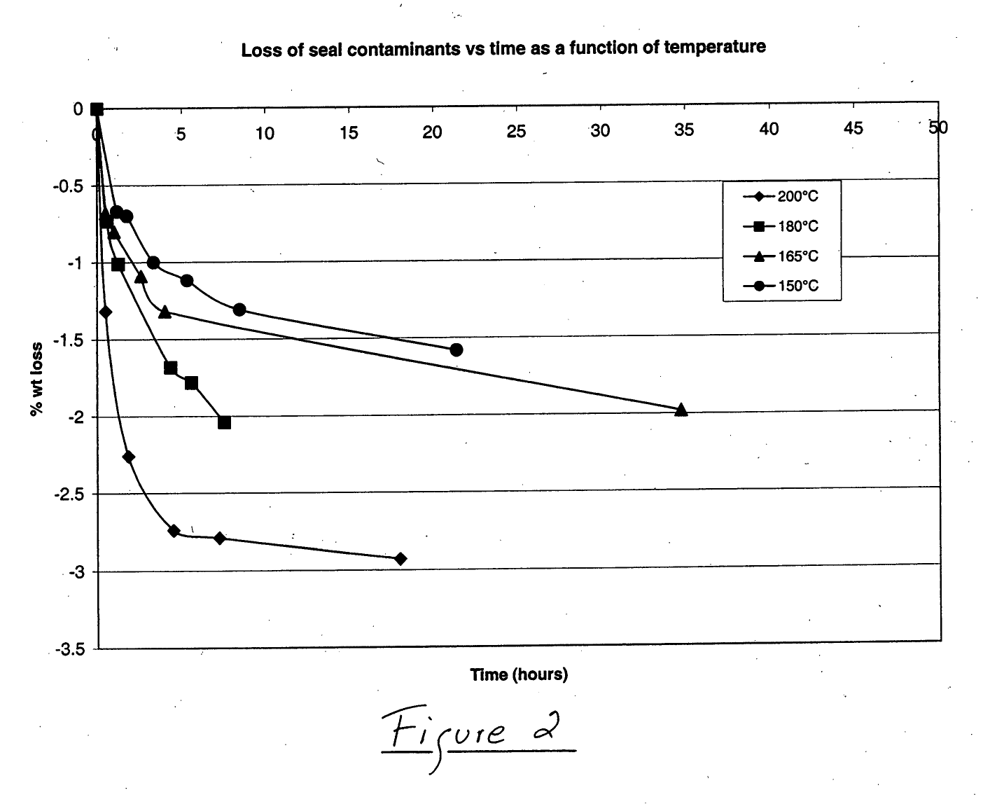

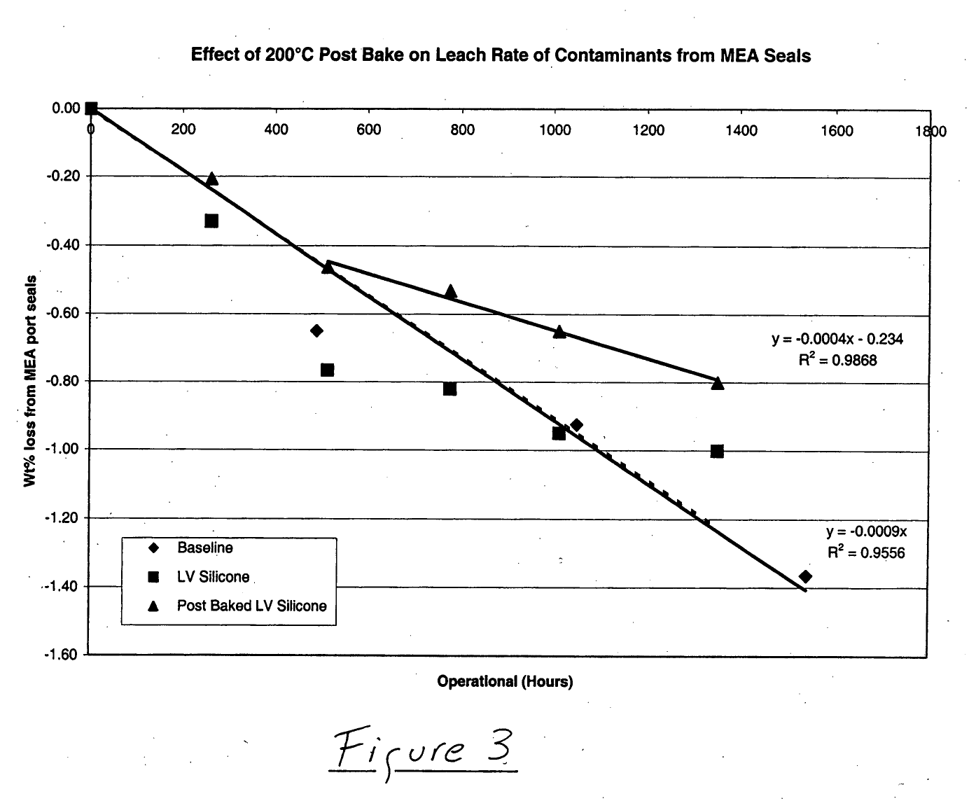

MEA 10 is then heated at a temperature greater than 120° C. In order to effect adequate evaporation of the mobile siloxanes, MEA 10 may be heated at a temperature of at least 150° C. for a period of at least 30 minutes. More typically, MEA 10 is heated at a temperature of about 200° C. for about 2 hours. FIG. 2 shows how seals' weight vary, as a function of time, when heated at various temperatures. Assuming seals typically have a 3.3% (weight) content, FIG. 2 gives an approximation of the percentage of VOCs that are removed by heating assembled MEAs. For example, pursuant to FIG. 2, heating an assembled MEA at 200° C. for 2 hours would result in approximately 75% of VOCs being removed (i.e., 2.5% of 3.3%). FIG. 3 shows the rate of extraction of contaminant siloxanes from integrated MEA port seals to be significantly decreased upon post baking the MEA. In this example a ‘low volatile’ version of the seal material showed no improvement to the rate of weight loss as compared to the baseline. However, the effect of post baking at 200° C. for 1 hour had a marked improvement in reducing the loss of volatile siloxanes, presumably due to the loss of the most volatile fraction, which may not be completely removed during the processing of various components of the rubber formulation.

MEA 10 should not be heated beyond temperatures that would lead to irreversible damage to any of its parts. For example, for MEAs using Nafion® membranes, which has a thermal degradation temperature limit of about 270° C., and silicone seal material, which has a decomposition temperature of about 210° C., the upper limit should be 210° C.

### EXAMPLE

A conventional MEA was subjected to an embodiment of the present invention. The membrane electrolyte employed was Nafion® N112. The fluid diffusion layers comprised carbon fiber paper. The cathodes employed a conventional loading of carbon supported platinum catalyst and the anodes had a conventional loading of carbon supported platinum-ruthenium catalyst. The MEA was then bonded at 165° C., for 3 minutes followed by cooling at ambient conditions. The MEA was then cut to the desired size and a flow processable silicone elastomer was then injection molded into the edge of the MEA. The MEA was then heated at 200° C. for 1 hour. The MEA was then operated for 1600 hours. No observable failures (due to delamination, change in membrane dimensions or performance losses) occurred. Consequently, in general, no performance difference was observed between the heated MEA and a baseline MEA (i.e., one that was not heated).

Because heating the MEA for 1 hour has not lead to any notable damage to the ion-exchange membrane or the assembled MEA, it is believed that heating the MEA for two hours will also not lead to any such damage while further decreasing the contaminant concentration.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for fabricating a membrane electrode assembly for use in an electrochemical fuel cell comprising:
i) providing an assembled membrane electrode assembly; and
ii) heating the assembled membrane electrode assembly at a temperature of at least 120° C. for at least 30 minutes.

2. The method of claim 1 wherein the heating step is performed at a temperature not exceeding temperatures that would lead to irreversible damage to any of its parts.

3. The method of claim 1 wherein the heating step is performed at a temperature of at least 150° C. for at least 1 hour.

4. The method of claim 3 wherein the heating step is performed at a temperature not exceeding temperatures that would lead to irreversible damage to any of its parts.

5. The method of claim 1 wherein the heating step is performed at a temperature of at least 200° C. for at least 2 hours.

6. The method of claim 5 wherein the heating step is performed at a temperature not exceeding temperatures that would lead to irreversible damage to any of its parts.

7. The method of claim 1 wherein the assembled membrane electrode assembly comprises:
a) two fluid diffusion layers,
b) an ion-exchange membrane interposed between the fluid diffusion layers,
c) an electrocatalyst layer disposed at the interface between the ion-exchange membrane and each of the fluid diffusion layers, and
d) a fluid impermeable integral seal impregnated in sealing regions of the fluid diffusion layers, wherein the seal comprises silicone.

8. The method of claim 3 wherein the assembled membrane electrode assembly comprises:
a) two fluid diffusion layers,
b) an ion-exchange membrane interposed between the fluid diffusion layers,
c) an electrocatalyst layer disposed at the interface between the ion-exchange membrane and each of the fluid diffusion layers, and
d) a fluid impermeable integral seal impregnated in sealing regions of the fluid diffusion layers, wherein the seal comprises silicone.

9. The method of claim 5 wherein the assembled membrane electrode assembly comprises:
a) two fluid diffusion layers,
b) an ion-exchange membrane interposed between the fluid diffusion layers,
c) an electrocatalyst layer disposed at the interface between the ion-exchange membrane and each of the fluid diffusion layers, and
d) a fluid impermeable integral seal impregnated in sealing regions of the fluid diffusion layers, wherein the seal comprises silicone.
